(19) United States
(12) Patent Application Publication
(10) Pub. No.: US 2003/0231000 A1
(43) Pub. Date: Dec. 18, 2003

(54) Method and apparatus for charging electric vehicles

(76) Inventor: Low Yow Teo, Singapore (SG)

Correspondence Address: MARTINE & PENILLA, LLP, 710 LAKEWAY DRIVE, SUITE 170, SUNNYVALE, CA, 94085, US

(21) Appl. No.: 10/171,613

(22) Filed: Jun. 17, 2002

(51) Int. Cl. H02J 7/00

(52) U.S. Cl. 320/101

(57) ABSTRACT

A battery charger for an electric vehicle is provided. The battery charger includes an air scoop to receive a flow of air. A turbine then receives the flow of air from the air scoop during vehicular operation. The flow of air causes the turbine to rotate. A generator coupled to the turbine generates electricity when the turbine rotates. The electricity generated by the generator charges a battery coupled to the generator.

### BACKGROUND OF THE INVENTION

1. Field of the Invention

The present invention relates generally to electrical vehicles or automobiles. More particularly, the present invention relates to a method and apparatus for recharging batteries in electric vehicles.

2. Description of the Related Art

An electric vehicle (EV) is a car, truck or van that uses grid electricity to power the vehicle instead of gasoline. Grid electricity is relatively inexpensive compared to most forms of fossil fuel (including oil) and may be generated from renewable energy sources such solar and wind energy. Although it has been a goal of most industrialized countries to reduce their dependencies on oil and reduce air pollution in the process, only in the recent few years has technology enabled the manufacturing of electric vehicles become practical.

In addition to purely battery powered electric vehicles (BEV), there are several other vehicle types that use electric power. For example, a hybrid electric vehicle (HEV) has electric components, but uses a fuel source instead of grid electricity to power the vehicle. A fuel cell vehicle (FCV) uses fuel cell instead of grid electricity to power the vehicle. Electric vehicles, whether powered by batteries, fuel cells, or gasoline hybrids, include an energy source and electronics capable of generating electricity. When connections are added to allow electricity to flow from cars to power lines, it is termed vehicle to grid (V2G) power.

Currently, battery electric vehicles provide for the greatest reduction in air pollution causing emissions. Unfortunately, the cost-effectiveness of a BEV is lower than either the cost-effectiveness of a HEV or FCV. In addition, operating a BEV also requires a great deal more maintenance than other types of vehicles. The standard amount of time required to refuel a BEV is about six to eight hours. In addition, most BEVs have a very limited range, even running on a full charge. For example, the EV1, manufactured by General Motors has a range of only about 88 kilometers to about 152 kilometers. Even with an additional battery pack, the EV1's range only increases about 30 to 40 kilometers.

In view of the foregoing, it is desirable to have a method and apparatus for charging EVs during vehicle operation. It is also desirable to charge an EV while the vehicle is being driven to increase the operating range of the vehicle as well as reduce recharging time when the vehicle is not being used.

### SUMMARY OF THE INVENTION

The present invention fills these needs by providing a method and apparatus for charging an electric automobile. It should be appreciated that the present invention can be implemented in numerous ways, including as a process, an apparatus, a system, a device or a method. Several inventive embodiments of the present invention are described below.

In one embodiment of the present invention, a battery charger for an electrical vehicle is provided. The battery charger includes an air scoop to receive a flow of air. A turbine then receives the flow of air from the air scoop during vehicular operation. The air scoop preferably directs the flow of air to one side of the turbine causing the turbine to rotate either in clockwise or counter clockwise fashion. The turbine preferably includes air holes to allow the release of air from the battery-charging system. A generator coupled to the turbine generates electricity when the turbine rotates. The electricity generated by the generator charges a battery coupled to the generator. The battery-charging system may also include a relay to allow the turbine to rotate only when the speed of the vehicle is high enough to generate an adequate air flow for the system.

In another embodiment of the present invention, a method for charging a battery in an electric vehicle is provided. The method begins by providing a flow of air to generate a force in a turbine coupled to a generator. The force generated rotates both the turbine and the generator. Electricity is generated by the said generator and is used to charge the battery. The air is preferably directed to one side of the turbine to ensure that the turbine rotates either in clockwise or counter clockwise fashion. Air flowing into the turbine is preferably released through a number of air holes formed on the turbine.

In yet another embodiment of the present invention, a battery charger for an electrical vehicle is provided. The battery charger includes an air scoop to receive a flow of air. A turbine then receives the flow of air from the air scoop during vehicular operation. The turbine preferably includes a pair of circular plates are that connected by a central spindle. A plurality of rectangular plates is coupled to the pair of circular places, and positioned radially along said pair of circular plates to preferably form air channels to receive the flow of air. The flow of air causes the turbine to rotate. A generator coupled to the turbine generates electricity when the turbine rotates. The electricity generated by the generator charges a battery coupled to the generator.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 illustrates a system for charging a battery in accordance with one embodiment of the present invention.

FIG. 2a illustrates a cross-sectional view of a battery-charging system fitted under the bonnet of an EV in accordance with one embodiment of the present invention.

FIG. 2b illustrates a top view of an upper strut bar in accordance with one embodiment of the present invention.

FIG. 2c illustrates a top view of a lower strut bar in accordance with one embodiment of the present invention.

FIG. 3 illustrates a schematic of a system for charging a battery in accordance with another embodiment of the present invention.

FIG. 4 illustrates a cross-sectional view of a battery-charging system fitted on the roof of an EV in accordance with another embodiment of the present invention.

FIG. 5 illustrates a perspective view of an EV in accordance with a further embodiment of the present invention.

FIG. 6 illustrates a method of charging a battery in accordance with one embodiment of the present invention.

### DETAILED DESCRIPTION OF THE PREFERRED EMBODIMENTS

A method and apparatus for charging an electric automobile is provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

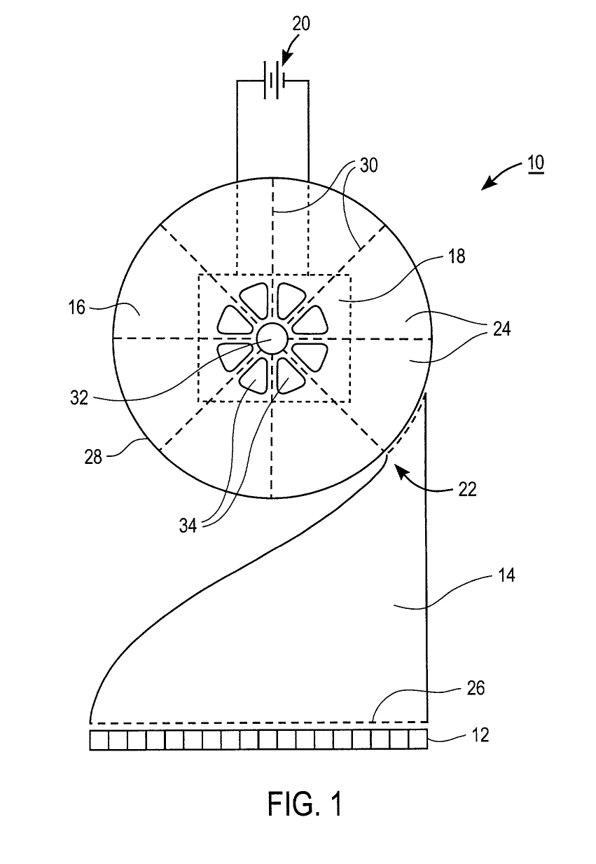

FIG. 1 illustrates a battery-charging system 10 in accordance with one embodiment of the present invention. Battery-charging system 10 comprises a grill 12 connected to an air scoop 14, which receives a flow of air. The force generated by the flow of air is then used to rotate a wind turbine 16, which is coupled to a generator 18, so as to generate a current to recharge a battery 20. Battery-charging system 10 is preferably located under the hood or bonnet of an EV.

Grill 12 acts as an air filter, preventing small object, such as rocks, from entering battery-charging system 10. Grill 12 therefore allows air to enter battery-charging system 10, while preventing foreign objects from interfering with the operation of turbine 16. Driving or operating the EV generates the current or flow of air. The air that enters battery-charging system 10 is then directed by air scoop 14 to one side 22 of wind turbine 16 where it enters an air channel 24. It will be apparent to a person skilled in the art that side 22 may be to the left or right of wind turbine 16 depending on the type of turbine that is employed.

An entrance 26 of air scoop 14 is preferably in the range of about 80 to about 110 centimeters, so that more air will be captured by the system. However, it should be appreciated that the size of entrance 26 is ultimately dependent upon and limited by the size of the vehicle. For example, a larger vehicle will presumably have more space to house and accommodate a larger air scoop 14 than a smaller vehicle.

Wind turbine 16 comprises two circular plates 28. A plurality of rectangular plates 30 is located radially between two circular plates 28 around a central spindle 32. Rectangular plates 30 divide wind turbine 16 into a number of air channels 24. Pressure exerted on rectangular plates 30 by a force generated by the current of air causes wind turbine 16 to rotate about central spindle 32. Air is allowed to exit via a plurality of air holes 34 on one or both of circular plates 28 at an end of air channel 24 nearest central spindle 32. Wind turbine 16 may be constructed of low-density metals or alloys, plastic, carbon fiber, fiberglass or other light and durable materials. It will be apparent to a person skilled in the art that wind turbine 16 is not limited to the design described herein. For example, another possible design for wind turbine 16 is a bladed turbine, with or without a housing.

Central spindle 32 couples wind turbine 16 to generator 18 so that the rotary motion of wind turbine 16 is transmitted to generator 18, which in turn, generates a current to recharge battery 20. Examples of batteries that could be charged with this system include a lead acid battery, a lithium-ion battery and a lithium (metal) sulfide battery. The type of battery employed depends on the purpose for which the EV was built, as well as the type of electric motor and the controller used. For instance, an EV built for racing would probably require a battery capable of generating more horsepower in the vehicle leading to better acceleration and a higher top speed.

Generator 18 may be either an alternating or a direct current (DC) motor, preferably one that utilizes a permanent magnet instead of field coils. Because field coils require power, some of the energy produced by wind turbine 16 will be consumed by the field coils instead, resulting in waste of power. Generator 18 may also be an automobile alternator. It is also preferable to have a low-dragging generator, which enables wind turbine 16 to rotate even when the vehicle is moving at low speeds.

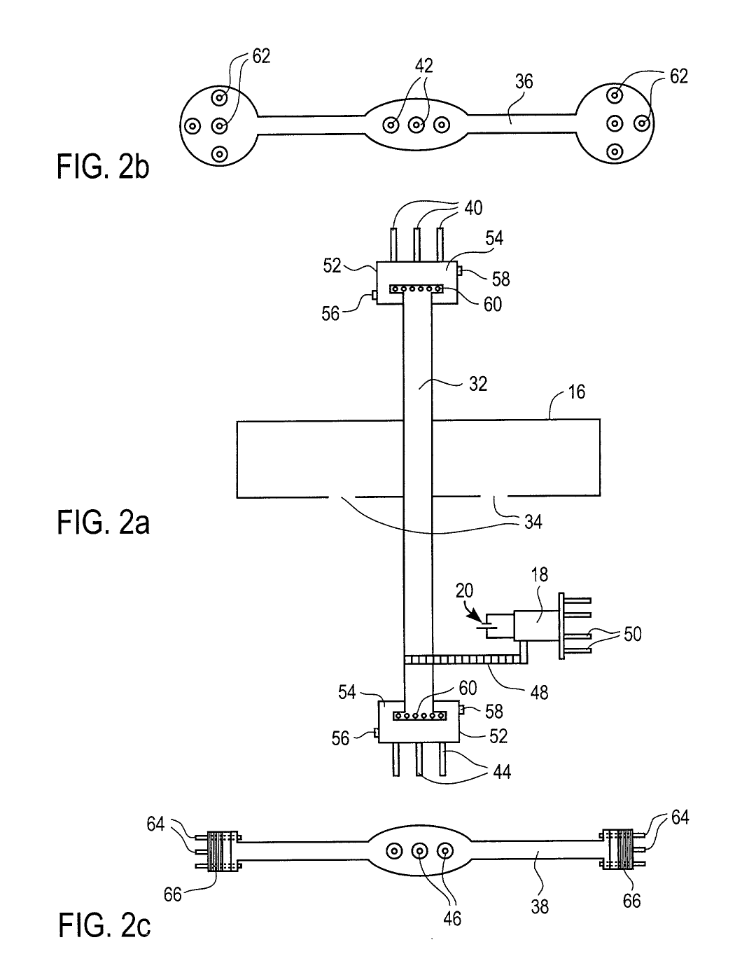

Although not depicted in FIG. 1, a relay may be implemented in battery-charging system 10 such that generator 18 begins charging battery 20 only when wind turbine 16 reaches a certain rotary speed. The relay may also be configured such that generator 18 goes offline when battery 20 is fully charged. Battery-charging system 10 may also be placed under the bonnet of an EV as demonstrated by FIGS. 2a, 2b and 2c. FIG. 2a is a cross-sectional view of battery-charging system 10 placed under the bonnet of an EV, FIG. 2b is a top view of an upper strut bar 36 and FIG. 2c is a top view of a lower strut bar 38.

Wind turbine 16 rotates around central spindle 32 and air escapes from wind turbine 16 via plurality of air holes 34. The upper end of central spindle 32 is connected by a plurality of bolts 40 and a plurality of nuts 42 to upper strut bar 36. Conversely, the lower end of central spindle 32 is connected by a plurality of bolts 44 and a plurality of nuts 46 to lower strut bar 38. Central spindle 32 transmits the rotary motion of wind turbine 16 to generator 18 via a belt 48. The current generated by generator 18 recharges battery 20. Generator 18 is preferably attached to the chassis of the EV with a plurality of bolts 50 and nuts (not illustrated), however as is well known in the art, there are many acceptable methods of attaching a generator to the chassis of a vehicle.

Each end of central spindle 32 is encased in a cylindrical support 52. Cylindrical support 52 is filled with lubricant 54. Lubricant 54 is changed on a regular basis by draining the contents of cylindrical support 52 through outlet 56 and adding fresh lubricant 54 through inlet 58 after approximately every 20,000 kilometers (km) of vehicular operation. Further lubrication of each end of central spindle 32 is achieved by employing a ball bearing system 60.

Upper strut bar 36 is attached to the chassis of the EV, preferably on top of the front suspension, by a plurality of nuts 62 and bolts (not illustrated). Lower strut bar 38 is attached to the chassis of the EV by a plurality of bolts 64 and nuts (not illustrated). A piece of hard rubber 66 separates lower strut bar 38 from the chassis of the EV and serves as a vibration absorber.

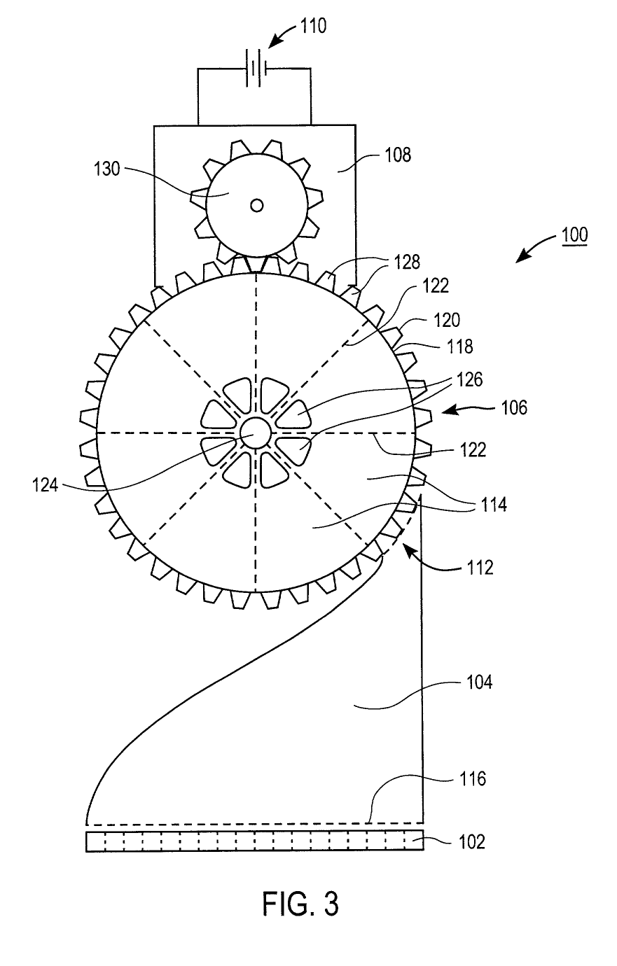

FIG. 3 illustrates a battery-charging system 100 in accordance with another embodiment of the present invention. Battery-charging system 100 comprises a grill 102 connected to an air scoop 104, which receives a flow of air. A force produced by the flow of air rotates a wind turbine 106, which is coupled to a generator 108, which in turn generates a current to recharge a battery 110. Grill 102 allows air into battery-charging system 100 during vehicular operation. The current of air passes through an entrance 116 of air scoop 104 and is directed to a side 112 of wind turbine 106 where it enters an air channel 114.

Wind turbine 106 comprises an upper circular plate 118 and a lower circular plate 120. A plurality of rectangular plates 122 is arranged radially between circular plates 118 and 120 around a central spindle 124. Rectangular plates 122 divide wind turbine 106 into a number of air channels 114. A force exerted on rectangular plates 122 by the current of air causes wind turbine 106 to rotate about central spindle 124. Air is allowed to exit via a plurality of air holes 126 on either of the circular plates 118 and 120, preferably lower circular plate 120 at an end of air channel 114 located nearest to central spindle 124.

Lower circular plate 120 includes a plurality of gear teeth 128 around its circumference, which engages a second gear 130 on generator 108. Although depicted in this embodiment as spur gears, it will be appreciated by a person skilled in the art that other types of gears such as helical gears, bevel gears and worm gears may be employed as well. In a preferred embodiment, gear teeth 128 are of an involute profile so that a constant ratio of rotational speed between lower circular plate 120 and second gear 130 can be maintained. In this way, the rotary motion of wind turbine 106 is transmitted to generator 108, which in turn, generates a current to recharge battery 110.

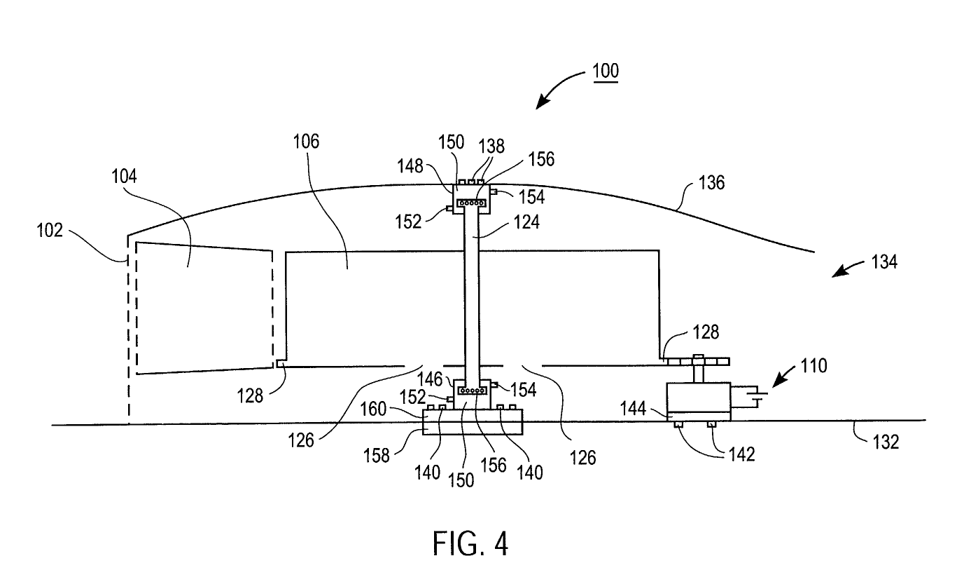

FIG. 4 is a cross-sectional view of battery-charging system 100 fitted on a roof 132 of an EV. Air enters battery-charging system 100 through grill 102 and is directed by air scoop 104 into wind turbine 106 during vehicular operation. Wind turbine 106 rotates around central spindle 124 and air escapes from wind turbine 106 via holes 126. Air eventually exits battery-charging system 100 via a rear end 134 of a housing 136 of battery-charging system 100. The upper end of central spindle 124 is connected by a plurality of bolts (not illustrated) and a plurality of nuts 138 to housing 136. The lower end of central spindle 124 is connected by a plurality of bolts (not illustrated) and a plurality of nuts 140 to roof 132.

Central spindle 124 transmits the rotary motion of wind turbine 106 to generator 108 when gear teeth 128 engage second gear 130 of generator 108. The current generated by generator 108 recharges battery 110. Generator 108 is attached to roof 132 by bolts (not illustrated) and nuts 142. A piece of hard rubber 144 separates generator 108 from roof 132 and acts as a vibration absorber.

Each end of central spindle 124 is encased in a pair of cylindrical supports 146 and 148. Cylindrical supports 146 and 148 are filled with lubricant 150. Lubricant 150 is changed on a regular basis by draining the contents of cylindrical supports 146 and 148 through outlet 152 and adding fresh lubricant 150 through inlet 154 after about every 20,000 km of vehicular operation. Further lubrication of each end of central spindle 124 is achieved by employing a ball bearing system 156 thereat. Cylindrical support 146 attached to the lower end of central spindle 124 is secured to a strap bar 158 under roof 132. A piece of hard rubber 160, placed between cylindrical support 146 and roof 132, acts as a vibration absorber.

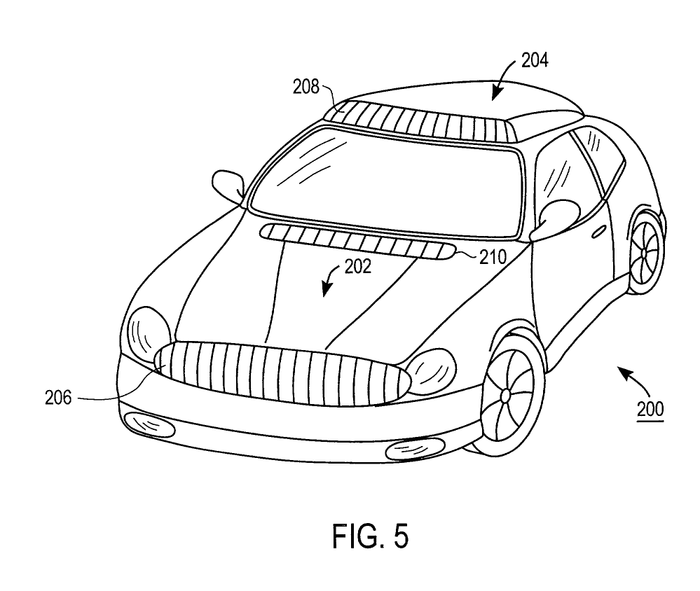

FIG. 5 is a perspective view of an EV 200 in accordance with one embodiment of the present invention. A first battery-charging system 202 is fitted under the bonnet and a second battery-charging system 204 fitted on the roof. Air flows into first battery-charging system 202 via grill 206 and into second battery-charging system 204 through grill 208. In addition, an optional air vent 210 may be mounted on top of the hood or bonnet of EV 200 to allow air exiting battery-charging system 202 to escape. Although a car is depicted in this embodiment, it is evident to a person of skill in the art that the battery-charging systems 202 and 204 may be fitted in other types of electric vehicles such as vans and buses as well. Further, it should also be appreciated that the roof and hood embodiments of the present invention may be consolidated to charge one battery-charging system in an EV.

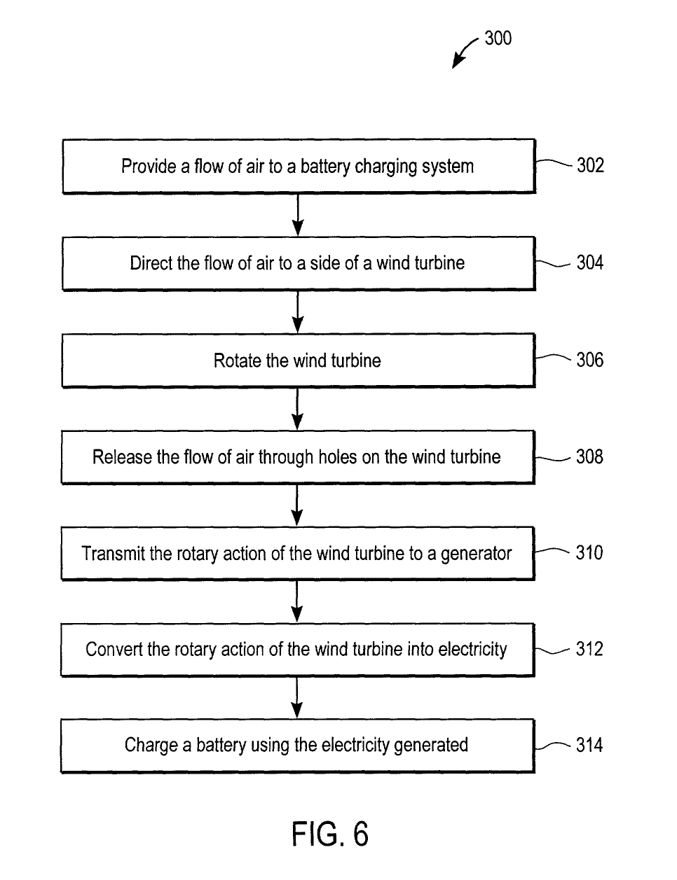

FIG. 6 illustrates a method 300 of charging a battery according to one embodiment of the present invention. An EV is accelerated to a particular speed, preferably about 30 km/hour, so that a flow of air with sufficient volumetric flow rate to generate a force to turn a wind turbine is provided in a block 302 to a battery-charging system. The flow of air is directed in a block 304 to one side of a wind turbine where it exerts a force on the wind turbine. The wind turbine is rotated in a block 306 by the force exerted by the flow of air. The flow of air is released in a block 308 from the wind turbine through holes on the wind turbine. The rotary action of the wind turbine is transmitted in a block 310 to a generator and converted in a block 312 by the generator into electricity. A battery is charged in a block 314 by the electricity from the generator.

By utilizing the present invention, the operating range of an EV is extended because charging of the EV battery occurs even while the vehicle is in operation. An EV using the present invention will be able to travel greater distances before the energy stored in its battery is depleted to the extent that the EV has to stop for a recharge. As electricity is being generated while an EV employing the present invention is in operation, the chances that the battery of the EV needs to be fully recharged are reduced. In addition, the amount of recharging time when the vehicle is not in operation is reduced.

Although EVs are being presently heralded as ultra-low emission vehicles (ULEV), and in some instances, as zero-emission vehicles (ZEV), critics argue that this is inaccurate as such vehicles merely transfer emissions from a tailpipe to a smokestack. Because the present invention taps energy from a zero-emission source—wind power, an EV using the present invention is therefore even more environmentally friendly than conventional EVs.

Other embodiments of the invention will be apparent to those skilled in the art from consideration of the specification and practice of the invention. Furthermore, certain terminology has been used for the purposes of descriptive clarity, and not to limit the present invention. The embodiments and preferred features described above should be considered exemplary, with the invention being defined by the appended claims.

1. A battery-charging system, comprising:
an air scoop to receive a flow of air, wherein said air scoop is located in a vehicle;
a turbine to receive said flow of air from said air scoop, wherein said flow of air is to generate a force to rotate said turbine;
a generator coupled to said turbine, wherein electricity is generated by said generator when said turbine rotates; and
a battery coupled to said generator, wherein said battery is charged by said generator.

2. A battery-charging system as recited in claim 1, wherein said vehicle is an electric vehicle.

3. A battery-charging system as recited in claim 2, wherein said air scoop directs said flow of air to only one side of said turbine.

4. A battery-charging system as recited in claim 3, wherein said turbine includes holes, wherein said holes allow said flow of air to exit said turbine.

5. A battery-charging system as recited in claim 4, further comprising a relay coupled between said turbine and said generator, wherein said relay switches said battery-charging system on and off.

6. A battery-charging system as recited in claim 4, wherein said generator is coupled to said turbine by a belt.

7. A battery-charging system as recited in claim 4, wherein said generator is coupled to said turbine by a system of gears.

8. A battery-charging system as recited in claim 4, wherein said turbine comprises:
a pair of circular plates;
a central spindle to connect said pair of circular plates;
a plurality of rectangular plates coupled to said pair of circular places, wherein said plurality of rectangular plates are positioned radially along said pair of circular plates.

9. A battery-charging system as recited in claim 8, wherein said plurality of rectangular plates form a plurality of air channels to receive said flow of air.

10. A method for charging a battery, comprising:
providing a flow of air to generate a force in a turbine, wherein said turbine is coupled to a generator and wherein said flow of air is provided by operating a vehicle;
rotating said turbine and said generator in response to said force;
generating electricity from said generator; and
charging said battery.

11. A method for charing a battery as recited in claim 10, wherein said vehicle is an electric vehicle.

12. A method for charging a battery as recited in claim 11, further comprising directing said flow of air to a side of said turbine.

13. A method for charging a battery as recited in claim 12, further comprising filtering said flow of air.

14. A battery-charging system, comprising:
an air scoop to receive a flow of air, wherein said air scoop is located in a vehicle; a turbine comprising:
a pair of circular plates;
a central spindle to connect said pair of circular plates; and
a plurality of rectangular plates coupled to said pair of circular places, wherein said plurality of rectangular plates are positioned radially along said pair of circular plates;
wherein said turbine is to receive said flow of air from said air scoop, wherein said flow of air is to generate a force to rotate said turbine;
a generator coupled to said turbine, wherein electricity is generated by said generator when said turbine rotates; and
a battery coupled to said generator, wherein said battery is charged by said generator.

15. A battery-charging system as recited in claim 14, wherein said plurality of rectangular plates form a plurality of air channels to receive said flow of air.

16. A battery-charging system as recited in claim 15, wherein said vehicle is an electric vehicle.

17. A battery-charging system as recited in claim 16, wherein said air scoop directs said flow of air to only one side of said turbine.

18. A battery-charging system as recited in claim 16, wherein said turbine includes holes, wherein said holes allow said flow of air to exit said turbine.

19. A battery-charging system as recited in claim 18, further comprising a relay coupled between said turbine and said generator, wherein said relay switches said battery-charging system on and off.

20. A battery-charging system as recited in claim 18, wherein said generator is coupled to said turbine by a belt.

21. A battery-charging system as recited in claim 18, wherein said generator is coupled to said turbine by a system of gears.
